(19) United States
(12) Patent Application Publication
(10) Pub. No.: US 2018/0342129 A1
(43) Pub. Date: Nov. 29, 2018

(54) GAMING MACHINE HAVING A DISPLAY ALLOWING THE PASSING OF OBJECTS THROUGH ITS SURFACE

(71) Applicant: Bally Gaming, Inc., Las Vegas, NV (US)

(72) Inventors: Karl WUDTKE, Henderson, NV (US); Vernon BERNARD, Las Vegas, NV (US)

(21) Appl. No.: 15/985,013

(22) Filed: May 21, 2018

Related U.S. Application Data
(60) Provisional application No. 62/511,081, filed on May 25, 2017.

(51) Int. Cl. G07F 17/32; G07F 17/34

(52) U.S. Cl. CPC G07F 17/3211; G07F 17/3209; G07F 17/34; G07F 17/3239; G07F 17/3251

(57) ABSTRACT

Disclosed is a gaming machine cabinet having a display including at least one pass-through opening for receiving, dispensing, or both, objects such as currency, cashout tickets, player tracking cards or the like. In some operating modes of the gaming machine, a label is displayed on the display to indicate that the pass-through opening is in use or available for use. In other modes, the label is removed and the pass-through opening is essentially hidden while the display is used for its primary purpose.

### CROSS-REFERENCE TO RELATED APPLICATIONS

This application claims the benefit of U.S. Provisional Patent Application No. 62/511,081, filed on May 25, 2017, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates to gaming machine cabinets and, more particularly, to a gaming machine cabinet having a display capable of allowing the passing of objects such as both received and dispensed currency and/or various currency representative media, player tracking media and the like.

### BACKGROUND OF THE INVENTION

As gaming machine cabinets continue to grow in size, the problem of placing common player peripherals on an accessible face of the gaming machine become increasingly more problematic. Over the years, the primary display itself has become the element that mostly increases in size, resolution and shape. Player tracking systems, cash inputs, button panels and speakers are essential components that often get relegated to the underside of a button deck or attached extensions on the outside of a cabinet due to “lack of room”. With “pass-through” openings in the display, these key elements can now be placed behind the display in more unobtrusive and ergonomic locations. In different modes, video graphics around the openings can change. In certain modes, such as an attraction mode, labels around the openings can animate and call attention to their functionality as desired, i.e. “Insert Cash Here” or “Do you have a player's card?” In game mode, these labels can disappear and the game field can seamlessly occupy the entire display surface including the areas immediately adjacent to each relatively narrow pass-through opening.

The existence of holes in liquid crystal displays (LCD's) is not entirely new, though, previously, it has been difficult to manufacture holes in glass. Some examples may be found in the cell phone business. In the gaming industry, some gaming machines such as the Japanese Gamera game, manufactured by Rodeo, have cut windows in the backlighting structure of an LCD display to expose objects such as mechanical reels behind the video display. Some breakthroughs in the consumer market include the garment industry, where a watch hand shaft may penetrate a surrounding LCD display. Other examples may be found in automotive dash displays, which allow controls such as shafts to penetrate the display. Such arrangements may be fashioned by mating separate video displays such as described in U.S. Pat. No. 9,652,928 issued May 16, 2017 and titled ‘Gaming Machine, Gaming Machine Display and Method, the disclosure of which is incorporated by reference. None of these examples present openings in which objects may be passed back and forth between the front and rear of a singular display while retaining the integrity of the display's primary operation.

A gaming machine cabinet having a single display for game play, player controls and including at least one opening for either the receiving, dispensing, or both, of currency, player tracking cards or the like would be a stark improvement in the field of gaming. It would permit multi-provisioning related to the pass through to accommodate reception of user objects through the display, dispensing of objects to the user as well as defining the same for different operations. For example the pass through may be provisioned to receive, in a gaming environment, a value object from a player for reading to establish credits as well dispensing value objects to the player such as coupons, tickets or cards. The same pass through in another embodiment may be provisioned to receive a player card. Providing the pass through enables the display to occupy the greatest real estate on the device since extensions or other structures which would have been required for the functions now accommodated by the pass through can be eliminated.

The concept of a pass through for a video display could also be used in other applications such as automatic banking terminals (ATMs), interactive kiosks, devices using mechanical or physical structures such as arms or the like in combination with a video presentation.

### SUMMARY OF THE INVENTION

Briefly, then, and in general terms, the present invention provides a gaming machine including a cabinet housing having a display with at least one opening extending through the display with a receiving chute, a dispensing chute, or both, aligned to the opening. A device such as a card reader or a currency acceptor may be operatively arranged at one end of the receiving chute to receive an article or object inserted by a user through the opening. Similarly, a device such as a printer or currency dispenser may be operatively arranged at one end of the dispensing chute for dispensing an article or object through the opening to a user. In accordance with still other embodiments, the display may include a touchscreen. In one or more embodiments, one or more video-rendered labels identifying the intended use of the opening at a given point in time may be displayed adjacent to or surrounding the opening. In some embodiments, the labels may be modified or removed from the display when the opening is not available for use to maximize the video real estate for content displayed at the display. In one or more embodiments, the edges of the opening may be rounded or chamfered. In still other embodiments, a bezel may extend through or be placed adjacent to the opening on either the front or back side of the display.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is an isometric view of a free-standing gaming machine according to an embodiment of the present invention.

FIG. 2 is a schematic view of a gaming system including the gaming machine.

FIGS. 3A-3C are images of an exemplary basic-game screen of a wagering game displayed on the gaming machine in accordance with one or more embodiments.

FIG. 4 illustrates an example of modification to various layers of a gaming machine display in accordance with one or more embodiments.

FIG. 5 is a flowchart for a method in accord with at least some aspects of the disclosed concepts.

### DETAILED DESCRIPTION

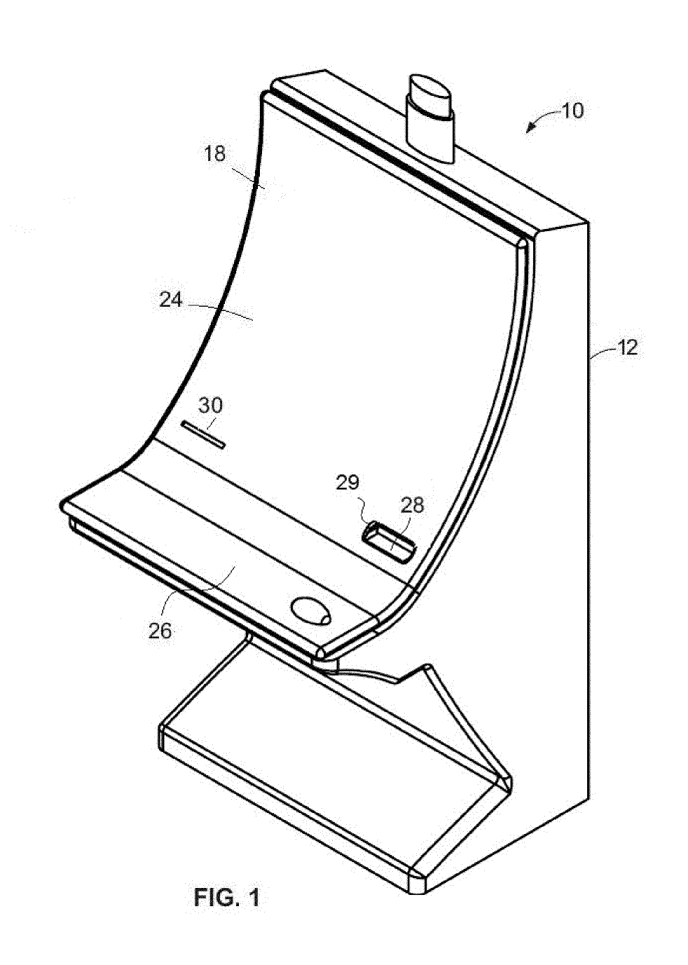

Referring now to the drawings, wherein like reference numerals denote like or corresponding parts throughout the drawings, and more particularly to FIG. 1, an upright gaming machine for play by at least one player (not shown) is generally shown at 10 in accordance with the present invention. In the preferred embodiment, the gaming machine 10 may present a video slot machine, a video keno game, a lottery game, a bingo game, a Class II bingo game, a roulette game, a craps game, a blackjack game, a video representation of a wheel or, or some other game of chance. The game could also involve a varying degree of player skill.

Referring to FIG. 1, there is shown a free-standing gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may or may not be primarily dedicated for use in playing wagering games. An exemplary type of gaming machine is disclosed in U.S. Pat. No. 6,517,433, which is incorporated herein by reference in its entirety.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door.

The input devices, output devices, and input/output devices are disposed on, and securely coupled to, the cabinet 12. By way of example, the output devices include a primary display 18, and one or more audio speakers (not shown). The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary display 18, a button panel 26, which may comprise physical button switches (not shown) or a touch-based button panel such as an iDeck® by Bally Gaming, a bill/ticket acceptor 28, a player tracking system panel 30 which may include a card reader/writer, a ticket dispenser (not shown), and player-accessible ports (e.g., audio output jack for headphones, video headset jack, USB port, wireless transmitter/receiver, etc.). Primary display 24 is typically a liquid crystal display (LCD), though other display technologies such as OLED, uLED or e-paper may be employed. It should be understood that numerous other peripheral devices and other elements exist and are readily utilizable in any number of combinations to create various forms of a gaming machine in accord with the present concepts.

The player input devices, such as a touch screen element associated with display 24, button panel 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/pay-out devices. The value input devices are used to deposit cash or credits onto the gaming machine 10. The cash or credits are used to fund wagers placed on the wagering game played via the gaming machine 10. Examples of value input devices include, but are not limited to, a coin acceptor, a bill/ticket acceptor accessible through opening 28 in display 24, a magnetic or smart card reader/writer accessible through opening 30 in display 24, a wireless communication interface for reading cash or credit data from a nearby mobile device, and a network interface for withdrawing cash or credits from a remote account via an electronic funds transfer. The value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer accessible through opening 30, a ticket dispenser for printing tickets redeemable for cash or credits which, in addition to bill/ticket acceptor 28, may be accessible through opening 28 in touchscreen 24 as described further below, a wireless communication interface for transmitting cash or credit data to a nearby mobile device, and a network interface for depositing cash or credits to a remote account via an electronic funds transfer.

It should be noted that while for aesthetic purposes the preferred embodiment of the present invention contemplates the use of a bezel 29 to define the opening 28, a pass-through opening can also easily be present in the display 18, including touchscreen 24, without the use of the bezel 29. Such an embodiment is illustrated by pass-through opening 30, which lacks a bezel. Such an opening 30 may be simply a slit or other opening occupying a minimal portion of the real estate of the display 18 and when not highlighted or identified by accompanying video graphics may be virtually imperceptible to the user.

In some embodiments, a single pass-through display opening may be used to both pass objects into the recesses of the gaming machine and to remove or dispense objects from the gaming machine. For example, U.S. patent application Ser. No. 14/863,049, entitled “Gaming Machine Having a Dual Chute,” incorporated herein by reference in its entirety, discloses an arrangement which provides an incoming paper path coupled to a currency acceptor and an outgoing paper path coupled to a substantially adjacent ticket printer, both paper paths sharing a common opening in the bezel. Such a bezel may be incorporated into or placed behind the pass-through display openings 28, 30 described by the present invention.

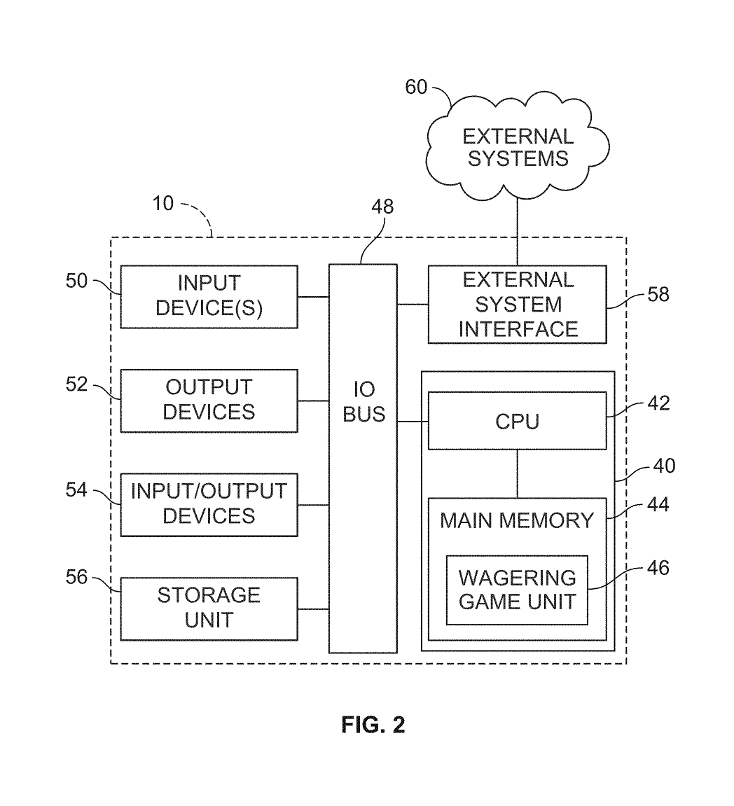

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

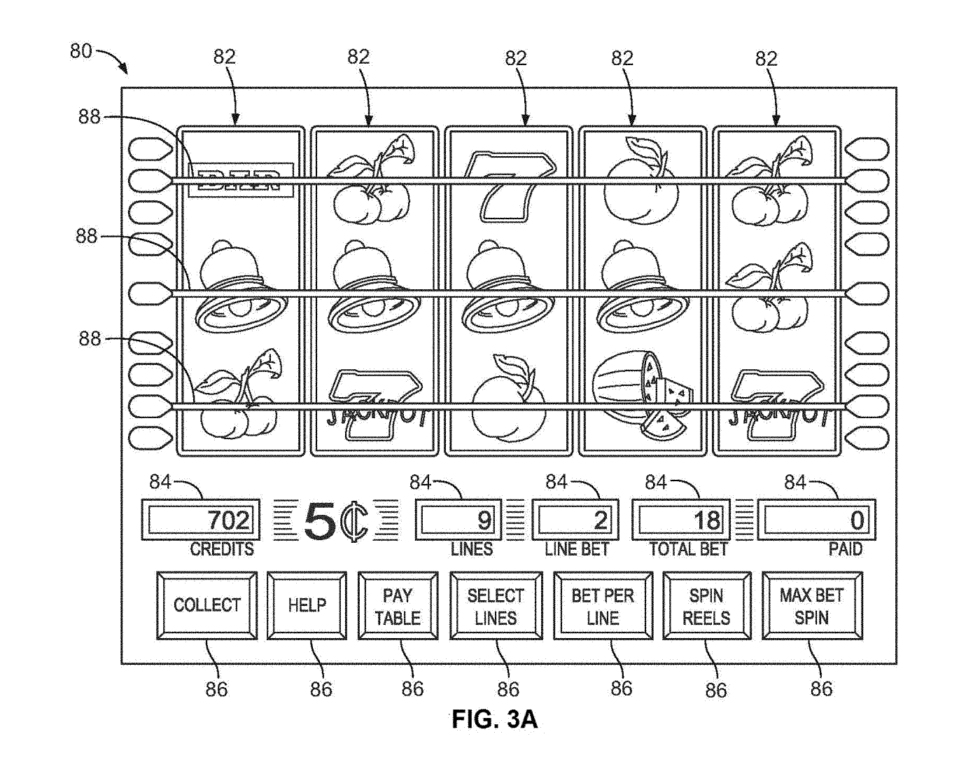

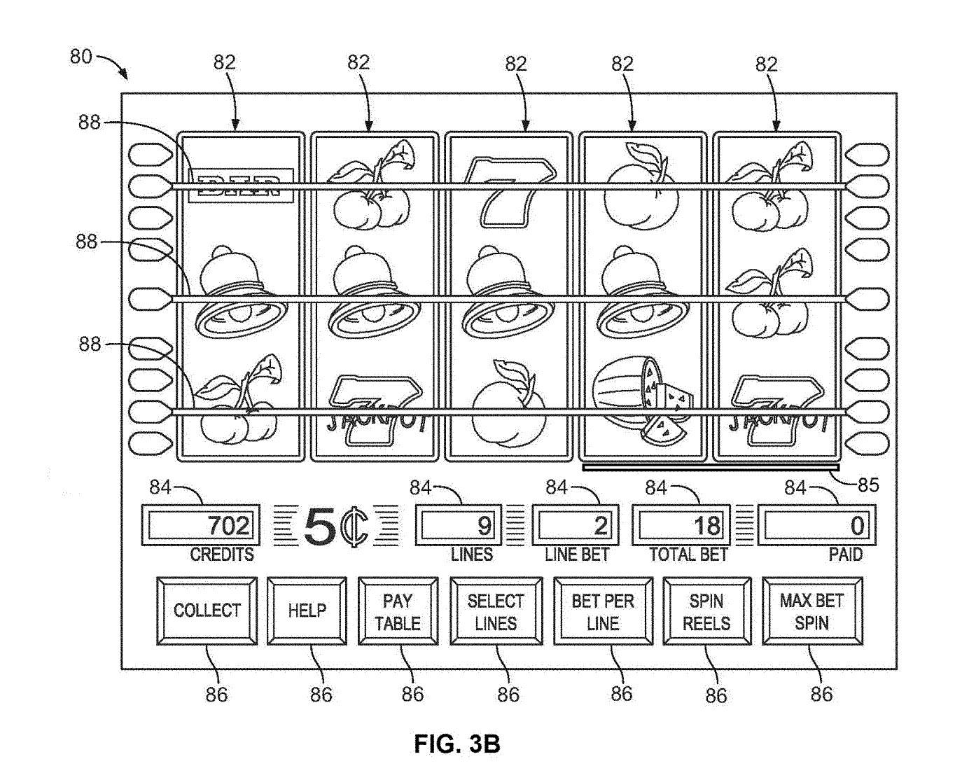

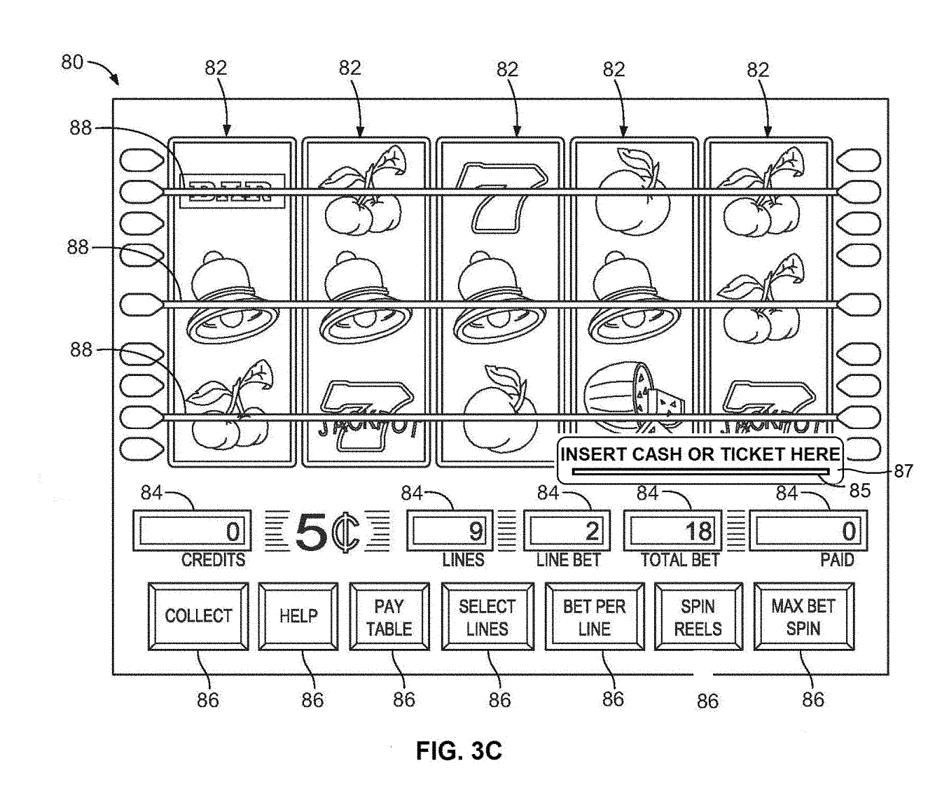

Referring now to FIG. 3A, there is illustrated an image of a basic-game screen 80 adapted to be displayed on the primary display 18. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 to display the wagering game.

In response to receiving an input indicative of a wager, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accordance with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

One of ordinary skill in the art will appreciate that not all gaming machines have all these components and may have other components in addition to, or in lieu of, those components mentioned here. Furthermore, while these components are viewed and described separately, various components may be integrated into a single unit in some embodiments.

Referring to FIG. 3B, in accordance with one or more embodiments, the basic game screen 80 described in FIG. 3A is illustrated displayed on a primary display 18 that has been modified to include a pass-through opening 85. As shown, in certain modes, such as game mode, no labelling is displayed adjacent to the opening 85. The game field seamlessly occupies the entire display surface including the areas immediately adjacent to opening 85.

In contrast, as illustrated in FIG. 3C in accordance with one or more embodiments, in certain modes, such as an attract mode, a video-rendered label 87 around the opening 85 is displayed to call attention to the current functionality associated with the opening. For example, in the event credit meter 84 indicates that there are no credits available for play, a currency acceptor behind the display 18 and coupled to opening 85 is enabled. In this situation, a label 87 rendered at the display 18 may be displayed adjacent to or surrounding pass-through opening 85. For example, as shown, the label may display, “Insert Cash or Ticket Here.” In one more embodiments, the label 87 may be generally static. In other embodiments, the label 87 may be animated, for example, it may flash, to especially draw attention to the opening 85. After accepting a bill, the label 87 can disappear and the game field can again seamlessly occupy the entire display surface including the areas immediately adjacent to the relatively narrow pass-through opening 85. When the label 87 is not rendered it can be appreciated that the opening 85 may be virtually imperceptible at the video display 80. It can further be appreciated that by providing the opening 85 through the display 80 the video display can occupy most or a large portion of the available real estate for the gaming machine 10 since the utilities such as the cash or ticket acceptor can be nested behind the display 30 with an unobtrusive opening 85 to provide the pass through access.

To provide each of openings 28 and 30 of FIG. 1, a physical hole is cut through all layers of the LCD stack-up of main display 24, for example, its glass, touch sensor, liquid crystal layer, light films, back lighting structure, and sheet metal housing. As noted above, bezels or plastic or any other suitable material can be sandwiched on both sides of the hole to guide objects, for example, credit/player tracking cards, currency or tickets in or out of each opening. In one or more embodiments, OLED, e-paper and additional display technologies such as, but not limited to, those described above may allow this concept to be practiced with fewer layers to modify and/or customize.

Although “transmissive” LCDs that allow the viewer to see through portions of the display are known, for example, as disclosed at least in U.S. Pat. No. 6,517,433, incorporated herein in its entirety, these displays provide no physical opening that will permit objects to pass through since typical LCD technology does not allow for cutting a hole in an LCD while also allowing control of every pixel in the display and, if so equipped, touch matrices.

For example, modern LCD monitors with touch interfaces typically consist of eight layers. Beginning with the layer nearest the user, these include a touch sensor, a transparent Projected Capacitive (PCT) ITO, laminated on the back of glass substrate; Front Polarizing Film, to direct light at the light at the intensity required by the image reproduction, laminated to the Color Filter Glass, which provides a broad array of color per pixel. The Liquid Crystal layer manipulates light in intensity required by image reproduction and the Thin Film Transistor (TFT) Glass regulates the Liquid Crystal layer. A Back Polarizing Film, at a right angle from the Front Polarizing Film, directs light at the intensity required by the image reproduction. This film is laminated to the Varying Optical Sheets, which magnify and harness the maximum brightness available from a Back Light structure and Reflector, which provides light to the system and improves efficiency by directing all available light toward the viewer of the image.

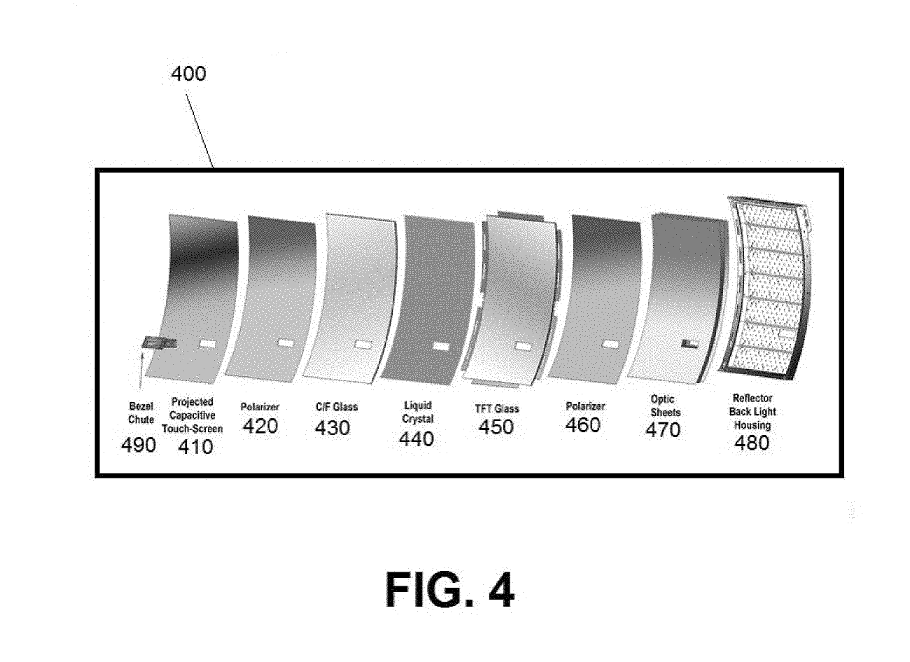

Construction of a pass-through display in accordance with one or more embodiments requires that each of the above layers be modified or custom designed. FIG. 4 illustrates an example of the various layers of an LCD display 400 modified with a pass-through opening. In the example, the touch sensor's PCT technology 410 detects touch through a transparent array of drive and sense lines which send touch location to a computer to be logged and processed. The drive and sense transceivers reside along the top x-axis and right y-axis on the outer border of the touch glass substrate, respectively. To simply place a hole in middle of this array would render operation to an area of the grid inactive. To resolve this issue, a custom PCT sensor is fashioned to provide additional transceivers along the other x and y axis, i.e. the bottom and left axis. This enables operation of the entire touch array except the voided area where the illustrated hole actually resides. The Front Polarizing Film 420 is manufactured to include a hole, as shown, at the desired location and laminated to the Color Filter Glass 430, which is based on a custom photo mask design which includes a hole, as shown, at the desired location. Similarly, a design of a custom liquid crystal mask is necessary to include a hole, as shown, at the desired location in the liquid crystal layer 440. The hole or holes are sealed similar to a standard LCDs glass edges, e.g. with a UV curing resin. Similar to the PCT layer, the TFT layer 450 typically consists of a transparent array of transistors which drive pixel output. The data and scan lines that connect/drive each pixel's transistor reside along the top x-axis and right y-axis on the outer border of the glass substrate, respectively. In order to place a hole in middle of this array that will not render operation of an area of the grid inactive, a custom TFT layer is fashioned to provide additional transceivers along the other x and y axis, i.e. the bottom and left axis. This enables operation of the entire array except the voided area where the hole actually resides. The back polarizing film 460 is also manufactured to include a hole, as shown, at the desired location and laminated to the TFT Glass layer 450. The Varying Optical Sheets 470 are die-cut to include a hole, as shown, at the desired location. The back light structure 480 includes an Edge Lit Panel (ELP) with a die-cut hole, as shown, in the desired location. In one or more embodiments, one or more bezels 490 may be placed in front of, behind, or through the opening display 400. Again, in one or more embodiments, OLED, E-paper or other display technologies may allow this concept to be practiced with fewer layers to modify and/or customize.

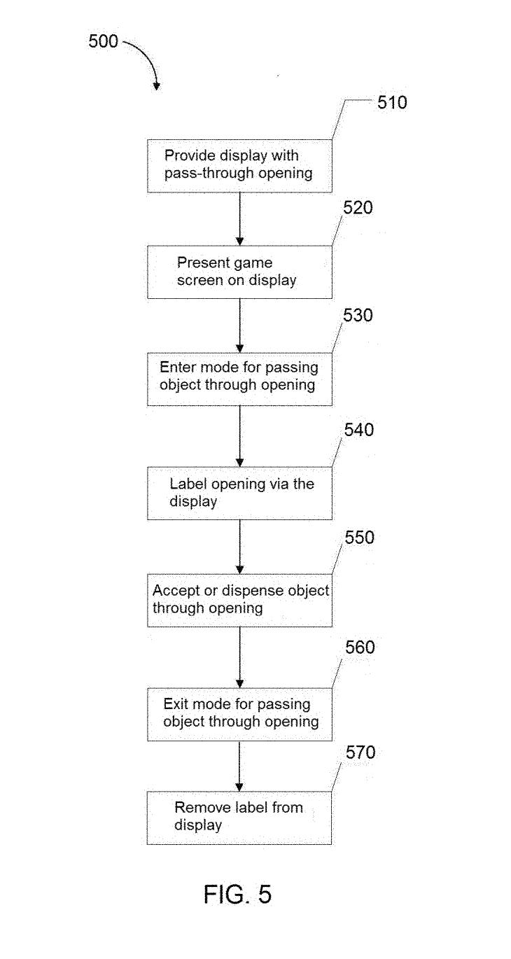

FIG. 5 illustrates one example of various operations 500 performed in accordance with one aspect of the present concepts including step 510, providing a gaming machine display with a pass-through opening, as described with respect to FIG. 4 above. The display, as described above, is coupled to a suitable housing and connected to a processor which provides display content to the display via video and touchscreen controllers that handle, among other well-known functions, addressing each pixel of the display for output and input, respectively. In step 520, a game screen, for example, basic game screen 80 of FIGS. 3A-C, is presented on the gaming machine display. In step 530, the gaming machine enters a mode in which an object is expected to be passed through the opening in the display. For example, the gaming machine may be preparing to issue a cashout ticket from a printer positioned behind the display or, as described with respect to FIG. 3B, the gaming machine may be expecting a player to insert a bill or ticket through the display into the machine by way of a currency acceptor positioned behind the pass-through opening. In step 540, a label describing the intended use of the pass-through opening may be displayed on the screen. One non-limiting example is shown in FIG. 3C. In step 550, the object is passed through the pass-through opening in the display. For example, a ticket is dispensed or a player tracking card is removed. Alternately, a bill, ticket, player tracking card or other such object may be inserted into the gaming machine via the pass-through opening in the display. In step 560, the gaming machine exits the mode for passing an object through the display. For example, normal game play mode may be resumed, at which point the special label displayed at step 540 is removed from the display in step 570.

FIG. 5, described by way of example above, represents one set of steps to perform the above described functions associated with the disclosed concepts. In variations within the scope of the invention, some steps may be omitted or performed in a different order. For example, steps 540 and 570 may be omitted.

The apparatus and methods described herein can be used for other devices such as ATMs, kiosks, point-of-sale terminals such as, for example, to receive currency or debit/credit cards.

The preferred embodiment described above is provided by way of illustration only and should not be construed to limit the claimed invention. Those skilled in the art will readily recognize that the claimed invention can be practiced in a substantially equivalent way with various modifications and changes that may be made to the claimed invention without following the example embodiments and applications illustrated and described herein, and without departing from the true spirit and scope of the claimed invention, which is set forth in the following claims.

What is claimed:

1. An apparatus for displaying content comprising:
a housing;
a video display supported by the housing, the video display comprising a pass-through opening that allows the passing of one or more objects through the video display and further comprising display control elements addressable for controlling video content in all areas of the video display surrounding the opening;
a processor;
a video controller for controlling the video display control elements to display first content on the video display associable with a primary function of the display and second content in close proximity to the pass-through opening to define a function associable with the pass-through opening.

2. The apparatus of claim 1 further comprising a touchscreen and a touchscreen controller addressable for detecting touch in all areas of the video display surrounding the opening.

3. The apparatus of claim 1 wherein the video display comprises LED technology.

4. The apparatus of claim 1 wherein the video display comprises OLED technology.

5. The apparatus of claim 1 wherein the video display comprises e-paper technology.

6. The apparatus of claim 1 wherein the video display comprises uLED technology.

7. The apparatus of claim 1 wherein the one or more objects comprise currency.

8. The apparatus of claim 1 wherein the one or more objects comprise tickets.

9. The apparatus of claim 1 wherein the one or more objects comprise a player tracking card.

10. The apparatus of claim 1 wherein the one or more objects comprise a magnetic card.

11. A method for operating a video display comprising a pass-through opening that allows the passing of objects through the video display comprising:
providing a video display comprising a pass-through opening that allows the passing of objects through the video display and further comprising display control elements addressable for controlling video content in all areas of the video display surrounding the opening;
displaying a basic game screen on the video display;
enabling a mode in which an object is expected to be passed through the pass-through opening;
displaying content in close proximity to the pass-through opening to define a function associated with the pass-through opening;
disabling the mode in which an object is expected to be passed through the pass-through opening; and
removing the displayed content in close proximity to the pass-through opening.

12. The method of claim 11 wherein the video display further comprises a touchscreen and a touchscreen controller addressable for detecting touch in all areas of the video display surrounding the opening.

13. The method of claim 11 wherein the video display comprises LED technology.

14. The method of claim 11 wherein the video display comprises OLED technology.

15. The method of claim 11 wherein the video display comprises e-paper technology.

16. The method of claim 11 wherein the video display comprises uLED technology.

17. The method of claim 11 wherein the one or more objects comprise currency.

18. The method of claim 11 wherein the one or more objects comprise tickets.

19. The method of claim 11 wherein the one or more objects comprise a player tracking card.

20. The method of claim 10 wherein the one or more objects comprise a magnetic card.
